(19) United States
(12) Patent Application Publication
(10) Pub. No.: US 2002/0120595 A1
(43) Pub. Date: Aug. 29, 2002

(54) DYNAMIC DOWNLOAD LINK LIST

(76) Inventors: PETER P. KIANG, BASKING RIDGE, NJ (US); MARK Y. MCKINNON, HOWELL, NJ (US)

Correspondence Address: MORGAN & FINNEGAN LLP, 345 PARK AVENUE, NEW YORK, NY, 10154

(21) Appl. No.: 09/327,511

(22) Filed: Jun. 8, 1999

(51) Int. Cl. G06F 7/00

(52) U.S. Cl. 707/1

(57) ABSTRACT

An apparatus includes a processor, a memory coupled to the processor, and a download program stored in the memory. The processor operates according to the download program to create a link list at the beginning of a downloadable file. The link list describes the number and size of the memory images that are being downloaded making downloading more flexible. Then the processor operates according to the download program to download the file to a base station. This reduces the amount of application download time and allows for incremental updates of separate pieces of application firmware.

### BACKGROUND OF THE INVENTION

1. Field of the Invention

This invention relates to non-volatile memory download of software image.

2. Description of the Related Art

Non-volatile memory (NVM) download is the capability of a controller board to change a software image on peripheral boards in a system, such as in a cellular base station in a cellular telephone system, through the system bus. The downloadable software image is usually called non-volatile memory (NVM) image and is a type of firmware. “Firmware” is low-level software that is directly interacting with hardware. “Non-volatile memory” means that the image stored in memory will not disappear when the power is turned off.

The ability to download software image is useful for fixing problems found in firmware or upgrading to new firmware as requirements change.

In previous practice, the size and number of application programs to be downloaded to an embedded system are fixed and there is no option for future expansion.

### SUMMARY OF THE INVENTION

In an illustrative embodiment of the invention, a downloadable file includes a set of images and a link list in front of the set of images. The link list improves the capability of a controller board to change a software image on peripheral boards in a system through the system bus.

In another illustrative embodiment of the invention, a method for non-volatile memory download of software image includes the steps of creating a link list at the beginning of a file, where the link list includes a record for each software image in the file, and downloading the file.

In another embodiment of the invention, an apparatus includes a processor, a memory coupled to the processor, and a download program stored in the memory. The processor operates according to the download program to download a file to a base station, where the file includes a set of images and a link list in front of the set of images.

In another embodiment of the invention, an article of manufacture for use in a computer system includes a computer useable medium having computer readable program code means embodied therein for downloading a file to a base station. The computer readable program code means includes computer readable program code means for causing a processor to create a link list at the beginning of a file containing a set of images, and computer readable program code means for causing a processor to download the file to a base station.

Other features and advantages of the invention will become apparent from the following detailed description, taken in conjunction with the accompanying drawing, which illustrates, by way of example, the features of the invention.

### BRIEF DESCRIPTION OF THE DRAWING

In the drawing:

FIG. 1 illustrates a downloadable file that includes a set of images and a link list in front of the set of images;

FIG. 2 illustrates the link list shown in FIG. 1;

FIG. 3 illustrates a record in the link list shown in FIG. 2;

FIG. 4 illustrates an embodiment of the invention in which a mobile switching office downloads a file to a base station; and

FIG. 5 illustrates an example of a dynamic download program depicted in FIG. 4.

### DETAILED DESCRIPTION

According to the present invention, a link list is created at the beginning of a downloadable file. The link list describes the number and size of the files to be downloaded making downloading more flexible. The link list is transparent to the downloading server, increasing capabilities without increasing the complexity of the server.

The invention adds flexibility to the design of embedded systems in the field and reduces the amount of application download time and allows for incremental updates of separate pieces of application firmware.

### Radio Interface Board (RIB) Firmware Design Specification

In an example of a specific application of the principles of the invention, a Code Division Multiple Access (CDMA) Radio Controller (the CRC) is the master controller board in a CDMA cell. “CDMA” is a digital wireless interface standard. The Radio Interface Board (RIB) is one of the peripheral boards that communicates with the CRC. The firmware resides in the RIB. The non-volatile memory (NVM) image that is downloaded to the RIB to replace, update or modify the firmware resident therein can include any, all or combinations of a Boot program image, a BLST program image, and one or two FPGA program images for the RIB in addition to the NVM program image. Therefore, the NVM update process has up to five separate images, each with its own checksum embedded at the end of the image. A link list will be sent at the very beginning of the download process to inform the current Boot code (program image) what is going to be updated. As each image comes in, a running calculation of the checksum is made, the Boot code (program image) will read the checksum that is embedded at the end of each image and compare it to the calculated checksum that was made for each image. If a checksum is incorrect when the end of any of the images is reached, the firmware (FW) will respond with a FAILED state in the PB_NVM_BLOCK_RESP message for the specific PB_NVM_BLOCK message. The CRC will then abort and restart the NVM update process.

The link list includes records for each file to be downloaded, then two bytes of checksum for the entire link list at the end. This link list is stored at beginning of the second page in the FLASH device. Each record of the link list is formatted as presented in Table 1, which illustrates a link list record of NVM download image:

TABLE 1

| | File | Starting | Starting | Ending | Ending | |
|---|---|---|---|---|---|---|
| Record | Type | Page | Address | Page | Address | Next Flag |
| 01000000003FFFA1 | Boot | 0 | 0 | 0 | 3FFF | Security code, more file |
| 02010000017FFFA1 | BLST | 1 | 0 | 1 | 7FFF | Security code, more file |
| 03024000037FFF11 | NVM | 2 | 4000 | 3 | 7FFF | Boot version upper byte 1, more file |
| 040E00000E7FFF61 | FPGA1 | E | 0 | E | 7FFF | Boot version lower byte 6, more file |
| 050F00000F7FFF00 | FPGA2 | F | 0 | F | 7FFF | No more files |
| 097A | Checksum | | | | | |

An example of the link list file with all images, with comments (all numbers in HEX), is presented in Table 2, which shows a sample link list for NVM download:

TABLE 2

| Byte | Description | |
|---|---|---|
| 0 | Image ID, where | 1 = Boot |
| | | 2 = BLST |
| | | 3 = NVM |
| | | 4 = FPGA1 |
| | | 5 = FPGA2 |
| 1 | Starting sector | |
| 2-3 | Starting address | |
| 4 | Ending sector | |
| 5-6 | Ending address | |
| 7 | Next Flag, where | 1 LSB bit for all files: |

0 = no more file
1 = more file(s)

4 MSB bits for files:

| | |
|---|---|
| Boot, BLST: | security code (must be 0 × A) |
| NVM: | Boot version upper byte |
| FPGA1 | Boot version lower byte |

The invention can be described more fully with reference to the FIGURES of the drawing, in which like reference numerals indicate like structural elements.

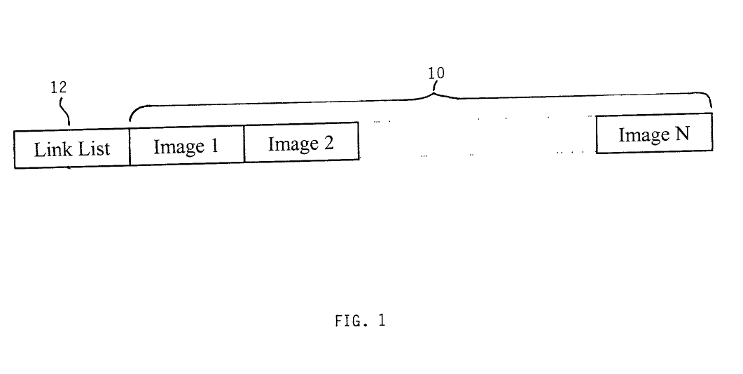

Referring to FIG. 1, a downloadable file includes a set of images 10 in a series from 1 to N (where “N” is an integer) which includes Image 1, Image 2, . . . Image N, and a link list 12 at the beginning of the set of images in accordance with the present invention.

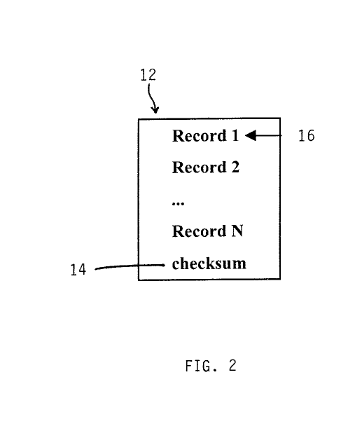

Referring to FIG. 2, the link list 12 includes a set of records in a series from 1 to N (where “N” is an integer), which includes Record 1, Record 2, . . . Record N, and a checksum parameter 14. The link list 12 indicates the number and size of each image for which there is a record.

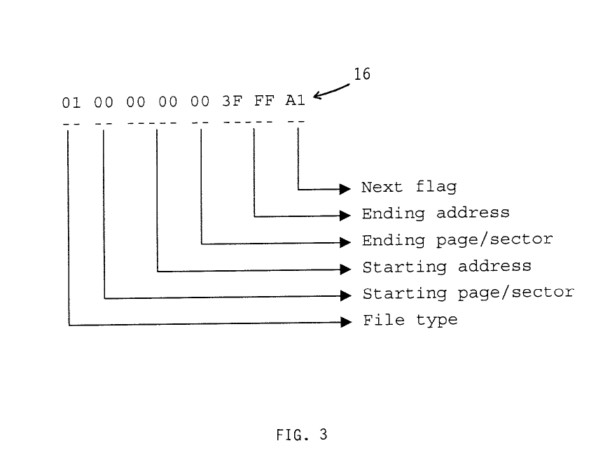

Referring to FIG. 3, a record, such as Record 1 of FIG. 2, in the link list 12 includes a set of hexadecimal numbers 16. Each hexadecimal number represents the following parameters (as shown in FIG. 3): “file type”, “starting page/sector”, “starting address”, “ending page/sector”, “ending address”, and “next flag” (which equals “0” if there are no more files).

By specifying the starting and ending page/address and the use of “next flag”, the number and size of each of the images in the download file become flexible.

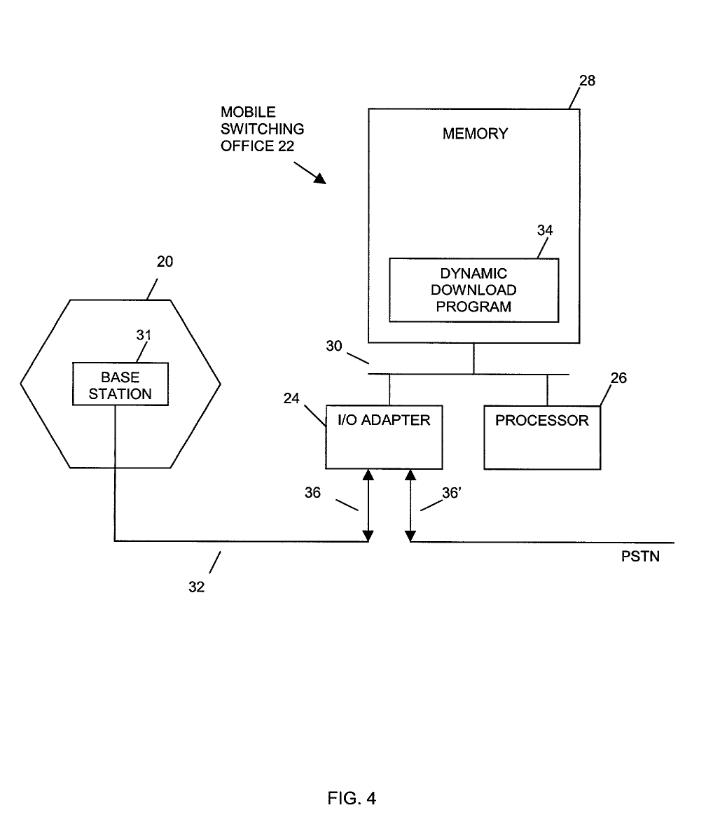

Referring to FIG. 4, an exemplary mobile cellular network includes a cell 20 and a mobile switching office 22. The mobile switching office includes an input/output (I/O) adapter 24, a processor 26, a memory 28, and a bus 30. The input/output (I/O) adapter 24 is in communication with the public switched telephone network (PSTN) and with the base station 31 of the cell 20 through a landline 32. The processor 26 is coupled to the I/O adapter 24 and to the memory 28 through the bus 30. The memory 28 is in communication with the I/O adapter 24 through the bus 30. The memory 28 stores a dynamic download program 34, which runs in the mobile switching office 22. The processor 26 within the mobile switching office 22 runs the dynamic download program 34 stored in the memory 28. The processor 26 controls data going into and out of the mobile switching office 22 through the I/O adapter 24 on communication line 36 and communication line 36′. The mobile switching office 22 downloads files containing software image from the mobile switching office 22 to the base station 31 according to the principles of the invention.

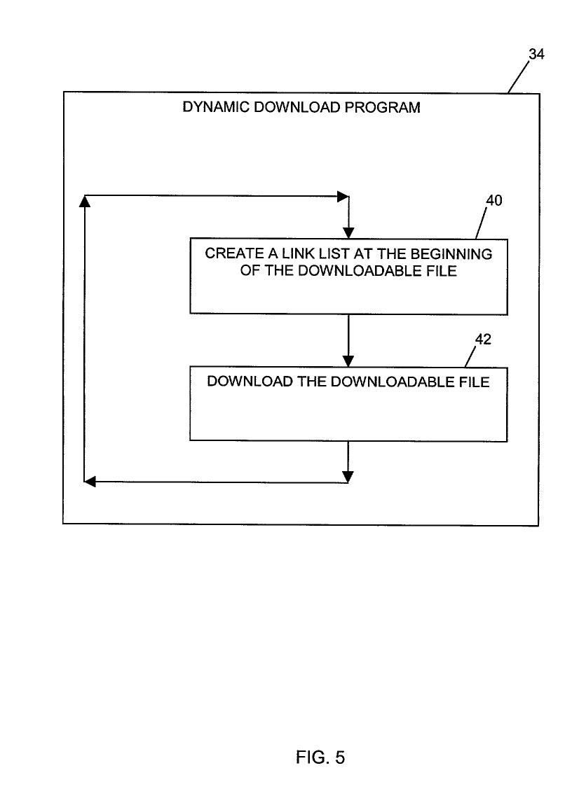

FIG. 5 is a flow diagram of an example of the dynamic download program 34 stored in the memory 28. Referring to FIG. 5, the dynamic download program includes a set of instructions which, when executed by the processor 26, cause the mobile switching office 22 to perform the following sequence of steps and repeat those steps during operation according to the dynamic download program 34. The downloadable file includes a set of images. A link list is created at the beginning of the downloadable file in step 40. The link list includes a record for each of the set of images, and the record indicates the number and size of each image in the set of images. The file is downloaded to the base station in step 42. The steps are repeated.

From the foregoing it will be appreciated that the invention improves the speed, convenience and flexibility of NVM download to fix problems found in firmware and upgrading to new firmware as requirements change. Power down of a system or pulling out of boards by technicians on the field, which is very costly and time consuming when there are thousands in the field, are not required. NVM download can now be performed remotely.

While several particular forms of the invention have been illustrated and described, it will also be apparent that various modifications can be made without departing from the spirit and scope of the invention.

What is claimed is:

1. A downloadable file, comprising:
a set of images;
a link list in front of the set of images;
wherein said link list includes a record for each of said set of images that indicates a number and size of each image in said set of images.

2. The file of claim 1, wherein:
said record includes a set of hexadecimal numbers.

3. The file of claim 1, wherein:
the link list includes a checksum parameter.

4. A method, comprising the steps of:
creating a link list at the beginning of a file that includes a set of images;
wherein said link list includes a record for each of said set of images that indicates a number and size of each image in said set of images; and
downloading said file.

5. The method of claim 4, wherein:
said record includes a set of hexadecimal numbers.

6. The method of claim 4, wherein:
said link list includes a checksum parameter.

7. An apparatus, comprising:
a processor;
a memory coupled to said processor; and
a download program stored in said memory;
wherein said processor operates according to said download program to download a file to a base station;
wherein said file includes a set of images and a link list in front of said set of images.

8. The apparatus of claim 7, wherein:
said link list includes a set of records.

9. The apparatus of claim 7, wherein:
said link list includes a checksum parameter.

10. An article of manufacture for use in a computer system, comprising:
a computer useable medium having computer readable program code means embodied therein for downloading a file to a base station, the computer readable program code means in said article of manufacture comprising:
computer readable program code means for causing a processor to create a link list in a file that includes a set of images;
wherein said link list includes a record for each of said set of images;
wherein said record indicates a number and size of each image in said set of images; and
computer readable program code means for causing a processor to download said file.
